(19) United States
(12) Patent Application Publication
(10) Pub. No.: US 2008/0277931 A1
(43) Pub. Date: Nov. 13, 2008

(54) CONNECTION FOR CONDUITS AND METHOD FOR MAKING IT

(76) Inventors: Uwe Poschenrieder, Koln (DE); Dominik Prinz, Elsdorf (DE); Marion Lorenz-Bornert, Bergisch-Gladbach (DE)

Correspondence Address: FRASER CLEMENS MARTIN & MILLER LLC, 28366 KENSINGTON LANE, PERRYSBURG, OH, 43551, US

(21) Appl. No.: 12/111,233

(22) Filed: Apr. 29, 2008

(30) Foreign Application Priority Data
May 5, 2007 (DE) 102007021846.1-12

(51) Int. Cl. F16L 35/00

(52) U.S. Cl. 285/332.1; 285/154.2

(57) ABSTRACT

The invention concerns a connection between a largely rigid pipeline and a flexible conduit element by means of a steel nipple, reaching with its one end into the pipeline and with its opposite end into the flexible conduit element, wherein the flexible conduit element is secured to the nipple by means of a clamping sleeve. The basic problem, to configure a flow-favorable connection between a rigid pipeline and a flexible conduit element so that a compact tie-in of the flexible conduit element is possible without the materials being affected by the type of connection technique, is solved in that the pipeline in the segment receiving the nipple and the clamping sleeve are subjected to magnetic pulse shaping coils to reduce a cross section thereof and the pipeline and the nipple have substantially the same inner diameter.

### CROSS-REFERENCE TO RELATED APPLICATION

This application claims priority to German Patent Application No. 10 2007 021 846.1-12, filed May 5, 2007, the entire disclosure of which is hereby incorporated herein by reference.

### FIELD OF THE INVENTION

The invention concerns a connection between a rigid pipeline and a flexible conduit element. The invention, furthermore, concerns a method for making such a connection between a rigid pipeline and a flexible conduit element.

### BACKGROUND OF THE INVENTION

Connections of the mentioned kind find application, for example, in refrigerant fluid lines, where for space and/or weight reasons or for reasons of a special requirement on the specific properties for the lines, the use of different materials may be necessary. Metallic materials, if possible, are joined by traditional welding or soldering. This, however, entails residues of the welding or soldering agents and/or high energy input and, what is more, it cannot be used for certain materials or combinations of materials. Flexible hoses can be fastened to stable-shape nipples by mechanically crimped or squeezed clamping sleeves, in which case there are very high demands on the precision of the process in order to achieve a stable and especially a tight connection.

From EP 0 154 588 B1 is known a pipe to pipe connection, whereby in a detachable coupling of two pipes joined via a sleeve and a tightening screw, a gasket is joined firmly to one pipe by electromagnetic shaping for purpose of a sealing by surface contact, before the connection between the two pipes is made by tightening the nut.

FP 0 841 108 A1 shows the connection of a metal pipe, having a plastic jacket, to a metallic fitting by magnetic pulse shaping, wherein the fitting reaches into the pipe and has projections on its outside for a secure joining to the inside of the pipe as it is deformed.

Thus, the two publications show the possibility of using magnetic pulse shaping in the joining of pipelines, but give no hint as to the possibility of improving pipe to hose connections by the use of magnetic pulse shaping.

U.S. Pat. No. 5,961,157 shows a connection between a rigid pipeline and a flexible conduit element by means of a nipple, where the pipeline is expanded in its terminal segment. The nipple has a thickening at the end face, which comes to bear against a shoulder of the pipeline at the beginning of the expansion, while the expanded region is reduced in its cross section by a mechanically produced corrugated folding. The diameter resulting from the folding is smaller than the diameter of the thickening of the nipple. In the region of the folding, the flexible conduit element is squeezed between the pipeline and the nipple. The drawback in this configuration is the reduction of the flow diameter at the transition between the individual elements and the absence of a tight connection between the nipple and the pipeline.

Starting from the known prior art, the basic problem of the invention is to organize the configuration and production of a connection between a rigid pipeline and a flexible conduit element so that a compact tie-in of the flexible conduit element is possible without the materials being affected by the type of connection technique.

### SUMMARY OF THE INVENTION

In concordance with the instant disclosure, this problem is surprisingly solved for this type of connection by a configuration with the features described herein.

Here, the connection between the rigid pipeline and the flexible conduit element is produced by a nipple, which is partly accommodated in the pipeline and partly in the flexible conduit element, joining the two conduit elements. Both the segment of the pipeline accommodating the nipple and the clamping sleeve for fixing the nipple to the flexible conduit element can be squeezed to reduce their cross section by magnetic pulse shaping. Under the effect of magnetic pulse shaping, the sleevelike elements are pressed together so that the elements are reduced in their free inner diameter for the most part uniformly and concentrically across their circumference and thus a radially inwardly acting force is exerted, by which the inside of the pipeline and the inside of the clamping sleeve are pressed and fixed against the outer circumference of the nipple, while the flexible conduit element is clamped and fixed between the inside of the clamping sleeve and the nipple.

The contraction of the clamping sleeve and the corresponding segments of the pipeline occurs in the entire region subjected to the magnetic pulse shaping. The choice of the parameters, such as the field strength of the electromagnetic field, the wall thickness of the elements being deformed, and the inner diameter of the elements prior to the deformation is done so that the elements being deformed are molded onto the nipple as a certain compressive force is built up, and the elements as they are deformed are able to mold themselves against a predetermined contour of the nipple. Since the nipple forms the abutment for the molding on of the pipeline and/or the clamping sleeve, it must have at least the same hardness as the components being deformed.

Also, the strength of the clamping sleeve is greater than that of the pipeline segment being deformed.

With the use of magnetic pulse shaping and the choice of materials, dimensions, and structural shapes made possible by this, not only is a compact, tight hose arrangement possible via the nipple arranged on the pipeline, but also the possible minimization of the diameter can minimize the surfaces of the flexible conduit element which are wetted by the fluid and, thus, the permeation of fluid through it. In particular, thanks to the invention, one can join a nipple of steel, for example, having a correspondingly slight thickness, to a pipe made of another metal, such as aluminum.

As the pipeline has an inner diameter largely conforming to the inner diameter of the nipple and a terminal broadening to accommodate the nipple, there is no change in the free flow cross section of the piping system. This leads, on the one hand, to improved noise behavior in the piping system and, on the other hand, to the lowest possible pressure loss in this area.

Advantageously, the clamping sleeve is joined as a separate part to the rigid pipeline or to the nipple and firmly connected to it, while the joining can be done by any known method, including magnetic pulse shaping.

In an alternative configuration, the clamping sleeve is part of the pipeline, while the pipeline in this second segment, further broadened with respect to the first segment, has an inner diameter which is suited to accommodating the flexible conduit element, into which the nipple is partly shoved. The broadening of the pipeline is chosen such that the flexible conduit element can be shoved into the expanded segment without expenditure of force or deformation.

Furthermore, it is in the meaning of the invention to connect the nipple permanently to the pipeline as protection against axial shifting and against twisting, so that after the connection the nipple can no longer be moved in the segment of the pipeline receiving it. Preferably, the connection is bonded, but it can also be a form fit or a friction fit.

It is especially advisable to weld the pipeline and the nipple by means of a magnetic pulse, after or at the same time as the magnetic pulse shaping, so as to produce a durable, tight and not releasable connection between the outside of the nipple and the inside of the pipeline.

With this type of microcontact surface welding, the corrosion vulnerability of the components caused by the welding process is increased to a lesser extent than for traditional welding methods.

Advantageously, the nipple has projections and/or depressions on its outer surface, which protect the arrangement of the nipple on both the pipeline segment receiving the nipple a d on the clamping sleeve or on the corresponding pipeline segment against axial displacement. An axial securement is created by the molding of the pipeline and the clamping sleeve onto the rigid nipple and thus also onto the projections and/or depressions of the nipple by the magnetic pulse shaping.

In a favorable embodiment of the invention, a protection against axial displacement is also arranged between the flexible conduit element and the nipple and/or between the flexible conduit element and the clamping sleeve, so as to prevent a separating of these elements after the magnetic pulse shaping, for example, during the operation of a refrigerant piping system. The protection can also be integrated into the clamping sleeve.

Furthermore, it can also be advisable to provide a seal, especially an annular one, between nipple and flexible conduit element, in order to prevent the escape of fluids from the piping system at this joint surface, and also advantageously the seal is inserted at least partly into a radial, circumferential recess on the nipple, and when the flexible conduit element is pressed against the nipple the seal is squeezed between these two components and a seal is formed between the two components in the axial direction.

As a further advantageous supplement to the invention, it is proposed to configure the pipeline in the segment receiving the nipple and/or the clamping hose in its segment receiving the flexible conduit element with an additional outer sleeve made from an electrically conductive, strong material.

With this additional sleeve, on which the magnetic pulse shaping acts, it is possible to improve, sustain, or even replace its cross section reducing action on the pipeline and the clamping sleeve, in order to achieve the desired degree of shaping for the pipeline.

The underlying problem of the invention, moreover, is solved by a method. The end of the pipeline is first broadened in order to receive the nipple, which has an inner diameter largely identical to the nonbroadened pipeline, and then fix it on the pipeline by the cross section reducing action of the magnetic pulse shaping. The molding-on by magnetic pulse shaping can occur in one or more steps.

Moreover, advantageously, the flexible conduit element partly shoved onto the nipple is fixed on the nipple by means of a clamping sleeve, joined to the rigid conduit element or the nipple, wherein the clamping sleeve embraces the flexible conduit element on the outside and is uniformly squeezed by magnetic pulse shaping to reduce its cross section and secure the flexible conduit element arranged between the nipple and the clamping sleeve.

In order to accelerate the method of producing the connection, furthermore advantageously several magnetic coils can be used at the same time, surrounding the treated pipeline segments concentrically and at a radial spacing, in order to subject the pipeline and the sleeve together to a magnetic pulse shaping.

In one embodiment, a connection between a largely rigid pipeline and a flexible conduit element is formed by means of a largely rigid nipple. The nipple reaches with its one end into the pipeline and with its opposite end into the flexible conduit element. The flexible conduit element is secured to the nipple by means of a clamping sleeve. The connection further includes the pipeline having an inner diameter largely corresponding to the inner diameter of the nipple. The pipeline has a broadening at the end to receive the nipple. The pipeline in the region of the segment receiving the nipple and the clamping sleeve are both squeezed by magnetic pulse shaping to reduce their cross sections.

In another embodiment, a method for connecting a largely rigid conduit element and a flexible conduit element by means of a nipple includes the steps of: broadening a free end of the pipeline to receive the nipple, the nipple connected to the flexible conduit element; introducing the nipple into the broadening; and concentrically molding the broadened segment of the pipeline on the nipple in a crimped connection by a magnetic pulse shaping. A connection between the largely rigid pipeline and the flexible conduit element by means of the largely rigid nipple is thereby provided.

### DRAWINGS

The above, as well as other advantages of the present disclosure, will become readily apparent to those skilled in the art from the following detailed description, particularly when considered in the light of the drawings described herein. The drawing shows:

FIGS. 1a-c shows the individual steps of a connection of a rigid pipeline to a flexible conduit element in longitudinal section,

FIGS. 2a-b show the connection shown in FIGS. 1a-c with parts preassembled,

FIGS. 3a-d show the connection shown in FIGS. 2a-b in an alternative embodiment,

FIGS. 4a-b show the connection shown in FIGS. 1a-c with an additional outer sleeve to strengthen the effect of the magnetic pulse shaping, and

FIG. 5 shows the arrangement of the clamping sleeve on the nipple with additional axial securement.

### DETAILED DESCRIPTION OF THE INVENTION

The following description is merely exemplary in nature and is not intended to limit the present disclosure, application, or uses. It should also be understood that throughout the drawings, corresponding reference numerals indicate like or corresponding parts and features. In respect of the methods disclosed, the steps presented are exemplary in nature, and thus, are not necessary or critical.

In the figures of the drawing, the same structural parts are given the same reference numbers.

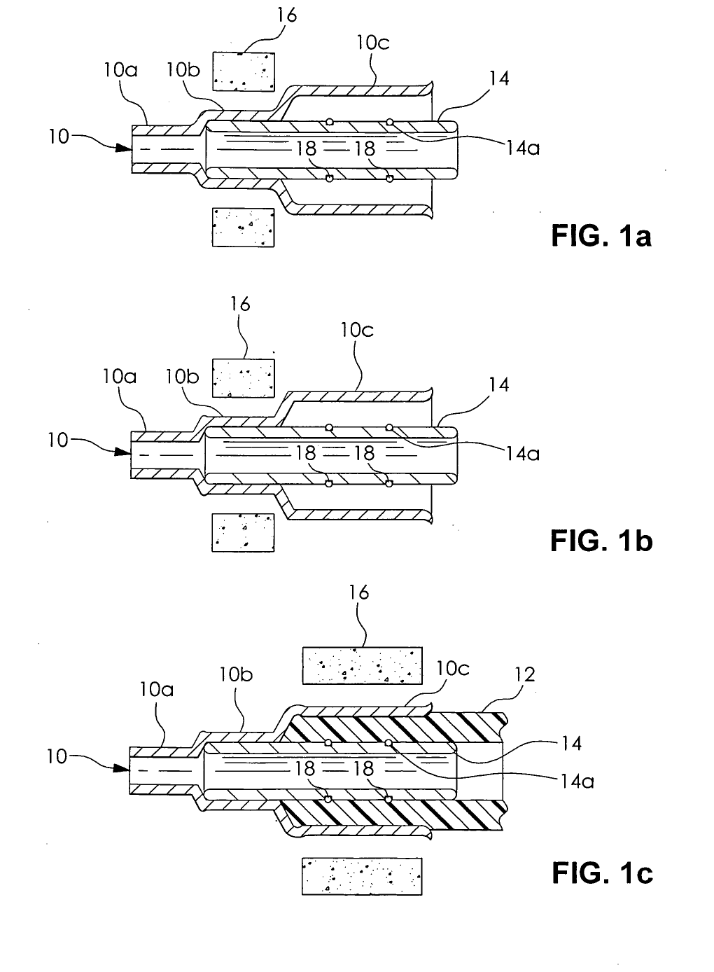

FIGS. 1a-c show the coupling in piping system, specifically, the connection of a rigid pipeline 10, configured as an aluminum pipe, for example, to a flexible conduit element, configured as a hose 12, wherein the flexible hose is a polymer hose, for example.

The connection shown in FIG. 1a-c between the aluminum pipeline 10 and the polymer hose 12 occurs via a nipple 14 made of stainless steel, which is connected to the two components of the piping system. The nipple 14 is in the form of a cylindrical sleeve, which reaches by one end segment into the pipeline 10 and by the opposite end segment into the hose 12.

In this embodiment of the invention, no other components are needed for the connection between the rigid pipeline 10 of aluminum and the flexible hose 12 of polymer.

Both the nipple 14 and the hose 12 are received by the pipeline 10, which for this purpose has segments 10b, 10c which are broadened relative to the segment 10a, which corresponds in its inner and outer diameter to the dimensions of the pipeline itself. In segments 10b, 10c, the pipeline is broadened in one stage at a time, while the wall thickness is largely the same as in segment 10a. Segment 10b with the first broadening stage is suitable to receive and secure the nipple 14, while the second broadening stage, located in the terminal segment 10c of the pipeline, is designed to receive the nipple and the hose 12, embracing it.

As is especially noticeable from FIG. 1a, the inner diameter of the pipeline 10 in segment 10b is slightly larger than the outer diameter of the nipple 14, so that this can be shoved in simple fashion and without fear of getting stuck into the region of the pipeline where the segment 10b passes by a steplike reduction of cross section into segment 10a and thus into the form of the nonbroadened pipeline 10. This steplike transition forms a stop when introducing the nipple 14, against which the nipple can rest.

The circular inner diameter of the nipple, configured as a cylindrical sleeve, corresponds ideally to the inner diameter of the pipeline 10 in its nonbroadened segment 10a, so that the fluid circulating in the system can flow through the clear passage of the nipple into the pipeline 10 without changes in cross section or steps causing turbulence with corresponding pressure loss and/or emission of noise in the pipeline.

As shown in FIG. 1a-c, in the method of the invention one arranges electromagnetic coils 16 in the region of the segments 10b, 10c of the pipeline being deformed, so as to induce eddy currents by the resulting magnetic field in the pipeline segments consisting of an electrically conductive material, while the current flowing in the magnetic field generates a force directed into the interior of the pipeline segments. The coils are each arranged concentrically to the pipeline segments being worked upon.

This force results in the cross section reducing deformation of the segments 10b, 10c under the action of the magnetic pulse shaping, as shown in FIGS. 1b and 1c, while the shaping of the two segments occurs in succession and the hose 12 is only shoved onto the nipple, now firmly arranged on the pipeline 10, after the shaping of the pipeline segment 10b, as shown in FIG. 1b. The steplike transition between the segments 10c and 10b forms a stop for the hose when it is introduced into the segment 10c of the pipeline.

During the deformation shown in FIG. 1b, not only a magnetic pulse shaping but also a magnetic pulse welding takes place, by which the stainless steel nipple 14 is firmly and inseparably connected to the aluminum pipeline 10 with improvement of its torsional strength. By an at least partial welding of the pipeline segment 10b to the nipple 14, the hold between the two components is provided not only by a frictional fit, but also by a bonding fit or a form fit.

In particular, the bonding connection of the nipple 14 to the pipeline 10 also improves the tightness to leakage of fluid in this area.

In the regions of the transitions between the individual segments of the pipeline, the deformations due to the magnetic pulse shaping are not as great, since these transitions for the most part extend in the radial direction and thus have a relatively large wall thickness in the direction of the force bringing about the deformation. Also, these transitions lie in the marginal regions of the respective magnetic field.

The nipple 14 in the embodiment depicted has two radial grooves 14a with an axial spacing, in each of which an O-ring 18 is inserted, the O-rings forming a seal between the hose 12 and the nipple 14, thus preventing an escape of fluid along the axially extending bearing surface.

Under the action of the deformed segment 10c of the pipeline, the corresponding segment of the hose is clamped between the segment 10c of the pipeline and the nipple 14, and in this way it is fixed in the manner of a hose clip. The flexible hose is also compressed in its wall thickness, but without affecting the free flow cross section for the fluid in this region, since this is formed by the inner diameter of the largely shape-stable steel nipple in this region.

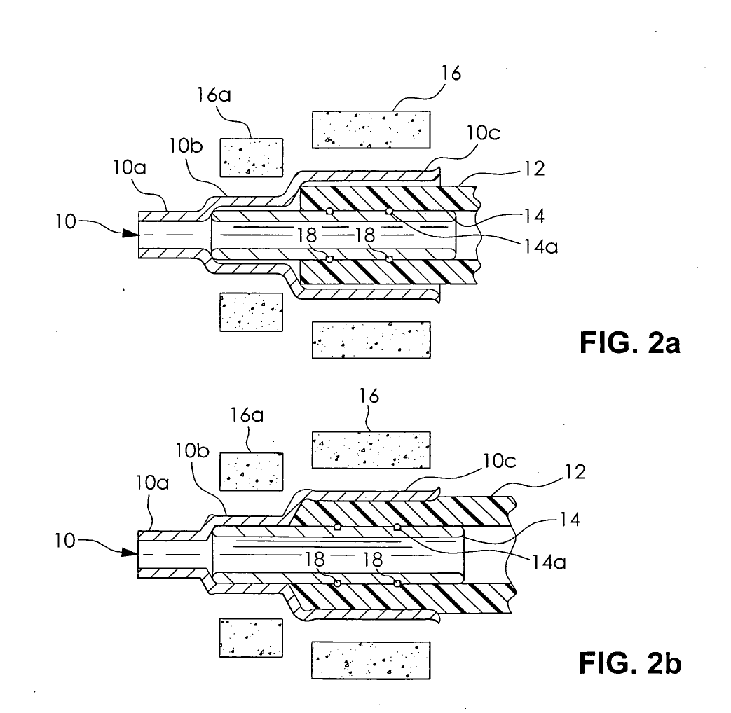

FIGS. 2a, 2b show how the aforementioned coupling takes place in only a single work step with a nipple 14 preassembled with the hose 12 and two magnetic pulse coils 16, 16a. The nipple 14, preassembled with the hose 12, is inserted into the terminal segment of the pipeline 10, which has been broadened into two steps, and the segments 10b, 10c are deformed to reduce their cross section by the eddy current fields generated by means of the magnetic pulse coils 16, 16a.

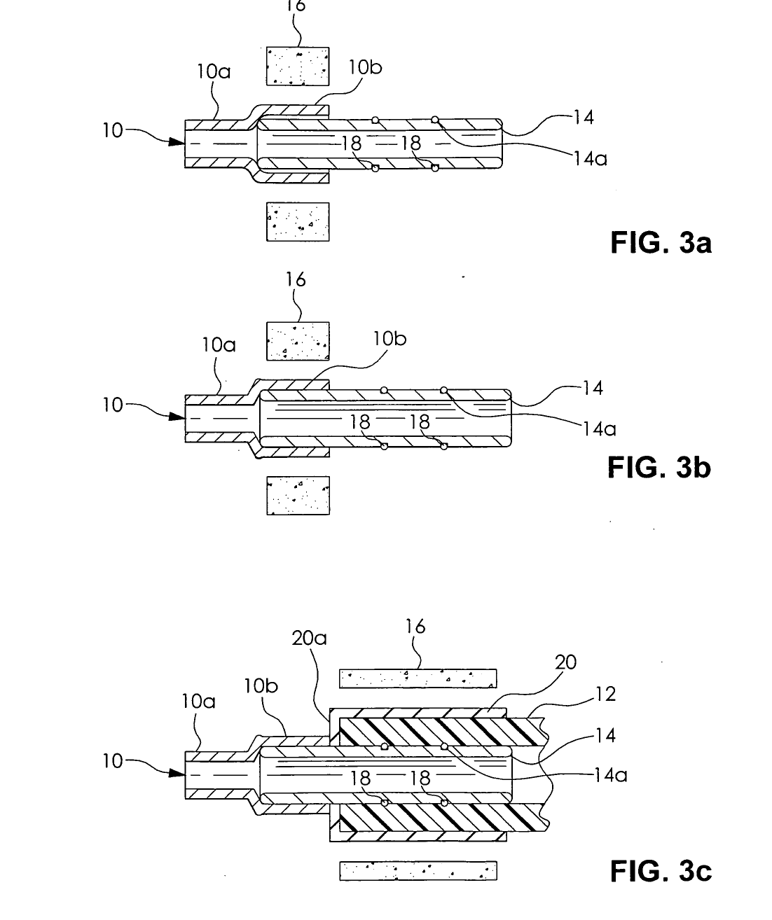

In the alternative embodiment of the invention shown in FIG. 3a-d, the pipeline 10 is only broadened in one step at the end to receive the nipple 14 in the segment 10b, forming the end segment of the pipeline. In a first step, magnetic pulse coils 16 at first mold the aluminum of the pipeline 10 by magnetic pulse shaping onto the nipple 14 and then, depending on the choice of coils, it can be connected at the same time or in a further step to the refined steel of the nipple by magnetic pulse shaping.

After the fastening of the nipple 14 to the pipeline 10, a preassembled unit consisting of the hose 12 and a separate clamping sleeve 20, encircling the hose, is shoved onto the end of the nipple 14 opposite the pipeline and fastened onto the nipple 14 by pressing, thanks to a magnetic pulse shaping with the coils 16. The separate clamping sleeve 20 is rotationally symmetrical and cup shaped, while the bottom 20a of the cup shape has an opening concentric to the lengthwise axis of the clamping sleeve, with which the clamping sleeve can be shoved onto the nipple 14. The diameter of this opening is only slightly larger than the outer diameter of the nipple 14, so that the bottom 20a can be brought to bear directly against the nipple, despite its radial orientation, by the magnetic pulse shaping, so as to increase the hold of the clamping sleeve on the nipple. In addition, there is an active connection and a form fit thanks to the crimping of the hose 12 between the deformed clamping sleeve 20 and the outer surface of the shape-stable nipple 14 and the resulting frictional fit of the hose at its inner surface with the nipple and at its outer surface with the clamping sleeve. In the manner described above, sealing rings 18 can be arranged between the nipple and the hose.

By the segment 20a, the clamping sleeve can also be joined in a first step to the nipple 14 or the pipeline segment 10b by conventional methods, and then prior to the cross section reducing magnetic pulse shaping of the clamping sleeve 20 the hose 12 is shoved between the nipple 14 and the clamping sleeve.

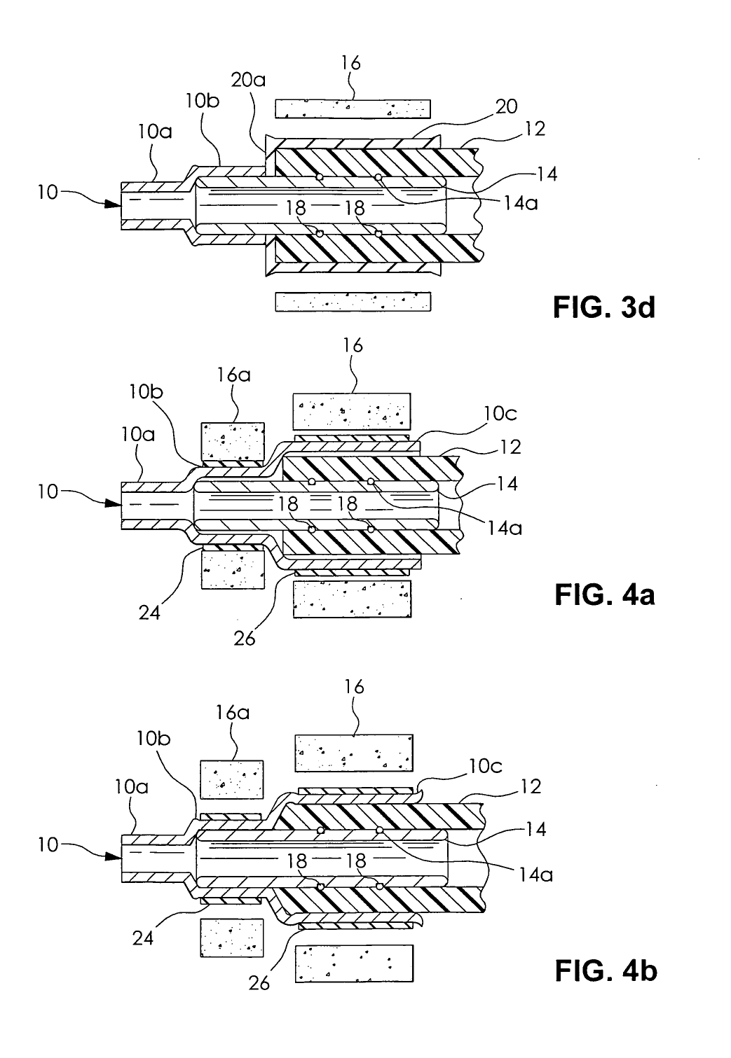

A further alternative embodiment of the invention is shown in FIG. 4a, 4b. in this variant, the pipeline 10 is broadened at the end in two stages to receive the nipple and the hose. But the eddy current field producing the deformation of the segments 10b, 10c is not induced in the pipeline itself, but rather in separate clamping sleeves 24, 26, which surround the pipeline segments 10b, 10c being deformed. The desired deformation of the pipeline segments 10b, 10c occurs indirectly, in that the clamping sleeves are deformed and these then act like presses to deform the pipeline segments. This alternative arrangement is especially advantageous when a particularly high degree of forming of the pipeline segments is necessary and/or the pipeline consists of an only slightly electrically conductive material. The material of the clamping sleeves, which does not make contact with the fluid from the piping system, can be chosen solely by the criteria of deformability and suitability for transmission of forces onto a body concentrically surrounding the material. The sole function of the clamping sleeves is to realize the desired deformation of the pipeline segments 10b, 10c, so as to arrange the nipple 14 both on the pipeline 10 and on the hose 12.

In the event that the nipple 14 is supposed to be formed from aluminum or a similar malleable material and therefore it would no longer be strong enough to serve as the abutment for the deformation of the pipeline and the clamping sleeve, without itself becoming deformed in cross section, the nipple can be configured with an inner sleeve (not shown) of steel or another deformation-resistant material on its inner surface, at least in the regions exposed to stress by the molding of the pipeline and/or the clamping sleeve under the action of the magnetic pulse. Such an inner reinforcement sleeve for the nipple can be used in all of the sample embodiments.

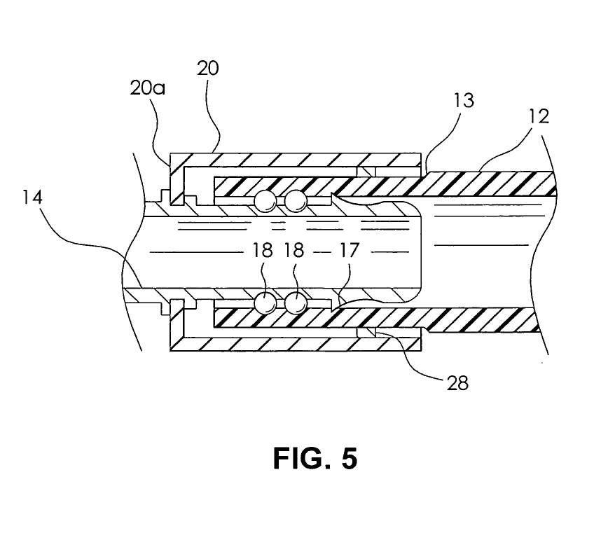

FIG. 5 shows a hose 12, which similar to the previously described sample embodiments is squeezed by the molding of a clamping sleeve 20 onto a steel nipple 14 between these two elements through magnetic pulse shaping and is secured in this way. The nipple 14 in this sample embodiment has securements against an axial displacement of the individual elements relative to each other. First, the bottom 20a of the clamping sleeve 20 is secured by axially spaced projections on the nipple 14, forming a radial circumferential groove 15, and furthermore can be connected firmly to the nipple 14 by traditional joining methods. Secondly, the nipple 14 has a projection 17, across which the hose 12 is shoved, and which forms a hook acting against the direction of pull-off of the hose 12 when the hose 12 is squeezed between the clamping sleeve and the nipple 14 by the pulse shaping.

As further axial securement, a ring 28 is provided, arranged concentric to the lengthwise axis of the nipple 14 and the hose 12, consisting of a harder material than the clamping sleeve 20, preferably steel, and being arranged between the latter and the hose 12. When the clamping sleeve is molded during the pulse shaping, the hose 12 is squeezed together in the region of the ring 28 and the clamping sleeve 20 is molded onto the harder ring 28. Thus, an axial securement is formed between the clamping sleeve and the hose 12 and, by interacting with the hook 17, also an axial securement of this unit relative to the nipple 14, wherein the ring 28 can be arranged in front of or behind the hook 17 in the pull-off direction.

The radially circumferential sealing rings 18 squeezed together after the pulse shaping also form an axial securement between the hose 12 and the nipple 14.

Furthermore, the hose 12 has a diameter reduction at its end, in the form of a shoulder 13, and the clamping sleeve 20 comes to bear against the diameter reduced region thanks to the pulse shaping, and the end face of the clamping sleeve forms a stop for the shoulder 13 of the hose in the entering direction.

Thus, with the present invention, it is possible to connect a coupling between a rigid pipeline and a flexible hose in simple and reliable manner by means of a nipple, connecting the two components, without the connection impairing or weakening the material or the structure of the components. The invented design is for the most part free of changes in the flow cross section or leakage.

While certain representative embodiments and details have been shown for purposes of illustrating the invention, it will be apparent to those skilled in the art that various changes may be made without departing from the scope of the disclosure, which is further described in the following appended claims.

What is claimed is:

1. A connection for conduits comprising:
a substantially rigid nipple having a first end and a second end;
a substantially rigid pipeline having a broadening at an end thereof to receive the first end of the nipple therein, the end of the pipeline squeezed by magnetic pulse shaping to secure the pipeline to the nipple; and
a substantially flexible conduit element having a clamping sleeve adjacent an end thereof, the clamping sleeve squeezed by magnetic pulse shaping to secure the conduit element to the second end of the nipple.

2. The connection according to claim 1, wherein the clamping sleeve is joined as a separate part to one of the pipeline and the nipple.

3. The connection according to claim 1, wherein the clamping sleeve is part of the pipeline.

4. The connection according to claim 1, wherein the nipple is permanently bonded to the pipeline.

5. The connection according to claim 4, wherein the pipeline and the nipple are joined by magnetic pulse welding.

6. The connection according to claim 1, wherein the nipple has at least one of a projection and a depression on an outer surface thereof.

7. The connection according to claims 1, wherein a protection device against axial displacement of one of the nipple, the pipeline, and the conduit element is arranged between at least one of the conduit element the nipple, and the clamping sleeve.

8. The connection according to claim 1, wherein at least one seal is arranged between the conduit element and the nipple.

9. The connection according to claim 8, wherein the seal is inserted at least partly into a recess formed on the nipple.

10. The connection according to claim 1, wherein the end of the pipeline receiving the nipple, and the clamping sleeve, has an electrically conductive outer sleeve with at least the same strength as the pipeline.

11. A method for connecting conduits, the method comprising the steps of:
providing a substantially rigid conduit element a substantially flexible conduit element, and a nipple connected to the substantially flexible conduit element;
broadening a free end of the substantially rigid conduit element to receive the nipple;
introducing the nipple into the broadened free end of the substantially rigid conduit element; and
concentrically molding the broadened segment of the substantially rigid conduit element on the nipple by magnetic pulse shaping.

12. The method according to claim 11, wherein the substantially flexible conduit element is fixed on the nipple by a clamping sleeve joined to one of the substantially rigid conduit element and the nipple.

13. The method according to claim 12, wherein the clamping sleeve embraces the substantially flexible conduit element on an outside thereof and is substantially uniformly squeezed by magnetic pulse shaping to reduce a cross section thereof and secure the substantially flexible conduit element between the nipple and the clamping sleeve.

14. The method according to claim 11, wherein the end of the substantially rigid conduit element is broadened in the axial direction in a second stage.

15. The method according to claim 14, wherein the second stage broadening is adapted to receive the nipple and the substantially flexible conduit element connected thereto.

16. The method according to claim 15, wherein the second stage broadening in a further step is molded by magnetic pulse shaping onto the nipple and the substantially flexible conduit element embracing it, in a crimped connection.

17. The method according to claim 11, wherein the two processes of magnetic pulse shaping are carried out by means of a corresponding number of coils in a single step.

18. A connection for conduits prepared according to a method comprising the steps of:
providing a substantially rigid conduit element, a substantially flexible conduit element, and a nipple connected to the substantially flexible conduit element;
broadening a free end of the substantially rigid conduit element to receive the nipple;
introducing the nipple into the broadening; and
concentrically molding the broadened segment of the substantially rigid conduit element on the nipple in a crimped connection by magnetic pulse shaping, wherein a connection between the substantially rigid conduit element and the substantially flexible conduit element by means of the nipple is provided.

19. The connection according to claim 18, wherein the substantially rigid conduit element in segments where a crimped connection is produced by magnetic pulse shaping are surrounded by a sleeve of electrically conducting metal.

20. The connection according to claim 19, wherein the electrically conducting metal has a strength at least as high as that of the substantially rigid conduit element.
